(19) United States
(12) Patent Application Publication
(10) Pub. No.: US 2004/0170336 A1
(43) Pub. Date: Sep. 2, 2004

(54) Dct matrix decomposing method and dct device

(76) Inventor: Masafumi Tanaka, Tokyo (JP)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/480,411

(22) PCT Filed: Mar. 20, 2002
(86) PCT No.: PCT/JP02/02663

(30) Foreign Application Priority Data
Jul. 11, 2001 (JP) 2001-210815

(51) Int. Cl. G06K 9/36; G06K 9/46

(52) U.S. Cl. 382/250; 382/276

(57) ABSTRACT

The purpose is the provision of each of a DCT matrix decomposing method and a DCT device, wherein the device decomposes a one-dimensional DCT matrix to make it possible to carrying out a DCT operation only through addition and subtraction. The method is characterized by comprising: a first step of decomposing an N×N one-dimensional DCT matrix into a plurality of sub-matrices and a zero matrix by using the symmetry of a cosine function; a second step of factorizing each of the sub-matrices to make it possible to express each of the sub-matrices by the product of an intermediate matrix and one or more first matrices the elements of which are 1, −1 or 0, wherein the intermediate matrix contains a cosine coefficient as a matrix element; and, a third step of repeating a factorization process of each of the intermediate matrices a desired number of times to make it possible to express each of the intermediate matrices by the product of second matrices the elements of which are 1, −1 or 0.

### TECHNICAL FIELD

The present invention relates to a DCT matrix decomposing method and a DCT device, and more particularly to: the DCT matrix decomposing method for performing a DCT operation only through addition and subtraction operations; and, the DCT device for processing an input signal through this DCT matrix decomposing method.

### BACKGROUND ART

A DCT (discrete cosine transformation) is known as an image compression technique in which a correlated imaged signal is orthogonally transformed into an uncorrelated signal. With certainty, the use of the image compression technique using the DCT widely spreads through the use of popular “Karaoke” and video games. Particularly, in the Internet, since multimedia in WWW becomes more and more popular, various types of WWW browsers support JPEG, which employs the DCT. Even in DVD, MPEG-2 using the DCT is employed.

In this DCT, for example, an image of a single frame is split into a plurality of blocks each having a size of 8 pixel×8 pixel. Each of the blocks is subjected to a two-dimensional DCT operation so that a compressed image is obtained. In a typical two-dimensional DCT, each row of an input image signal is sequentially subjected to a one-dimensional DCT operation so that intermediate data is obtained. This intermediate data has its rows and columns transposed. The thus transposed intermediate data is then subjected to the same one-dimensional DCT operation.

In the one-dimensional DCT operation of a single block having a size of 8×8 pixels, since eight components of an image signal is multiplied by a DCT matrix having 8 columns and 8 rows, a total number of multiplication operations reaches 64 times. The multiplication operation requires much more time in calculation than that required in addition and subtraction operations. In addition, a multiplier is much larger in scale than an adder and a subtracter. Also in power consumption, the multiplier is worse at high speed calculation in comparison with the adder and the subtracter.

On the other hand, there is a need for a high speed DCT operation in order to reduce a period of operation time required in processing the image signal through the DCT operation. As for an image transmission device, particularly, in a mobile type device, there is a strong need for considerable reduction of its power consumption.

In view of such circumstances, various types of techniques have been proposed for reducing the number of multiplication operations performed in the DCT operation. For example, “Chen algorithm”, which is a high-speed type of one-dimensional DCT operation, is employed in practice. This type of the high-speed algorithm reduces the number of multiplication operations by combining ones of the cosine coefficients in the DCT matrix, which ones are identical with each other in absolute value.

However, even in such high-speed algorithm, the multiplication operation is still required so that any further reduction in operation time is not easy in performing the DCT operation. Further, a DCT device for performing this type of algorithm comprises a multiplier, which makes it difficult to reduce the device in circuit scale and in power consumption.

### DISCLOSURE OF THE INVENTION

As described above, both the conventional DCT matrix decomposing method and the conventional DCT device are disadvantageous in further reducing both the circuit scale and the power consumption. Consequently, it is an object of the present invention to provide both a DCT matrix decomposing method for decomposing the one-dimensional DCT matrix and a DCT device for performing the method, wherein the DCT operation is performed only through addition and subtraction operations.

In order to accomplish the above object, provided here is a DCT matrix decomposing method of the present invention, the method characterized by comprising: a first step of decomposing an N×N one-dimensional DCT matrix into a plurality of sub-matrices and a zero matrix by using the symmetry of a cosine function; a second step of factorizing each of the sub-matrices to make it possible to express each of the sub-matrices by the product of an intermediate matrix and one or more first matrices the elements of which are 1, −1 or 0 in value, wherein the intermediate matrix contains a cosine coefficient as a matrix element; and, a third step of repeating a factorization process of each of the intermediate matrices a necessary number of times to make it possible to express each of the intermediate matrices by the product of second matrices the elements of which are 1, −1 or 0 in value.

In accordance with the present invention, the one-dimensional DCT matrix is decomposed into a plurality of sub-matrices and a zero matrix. Then, each of the sub-matrices is decomposed into the product of the intermediate matrix and the first matrix, or into the product of the plurality of the first matrices. In addition, the intermediate matrix is decomposed into the product of the plurality of the second matrices. Eventually, the DCT matrix is decomposed into: the sub-matrices expressed by the product of the first matrix and the plurality of the second matrices, or expressed by the product of the plurality of the first matrices; and, the zero matrix. Since the matrix elements of the first and the second matrix are 1, −1 or 0 in value, it is possible for the DCT operation using the DCT matrix of the present invention comprised of the first matrices or of the first matrix and the second matrices to determine in calculation the DCT coefficients only through addition and subtraction operations without performing any multiplication operation. Due to this, it is possible to improve the DCT operation in calculation speed.

In order to accomplish the above object, provided here is a DCT device of the present invention, the device characterized by comprising: a signal input portion for inputting an N point input signal; a signal selection portion for selecting a group of input signal among the N point signals, which group corresponds to one or more of a plurality of first matrices, or to the first matrix and a plurality of second matrices, wherein the first and the second matrices are obtained with respect of each of the sub-matrices defined in claim 1 by performing the first to the third steps defined in claim 1; an addition/subtraction portion for performing addition and subtraction operations for expanding the product of the first matrix and the plurality of the second matrices, or the product of the plurality of the first matrices with respect to the group of the input signals, which group depends on each of the sub-matrices and is selected in the signal section portion; a signal output portion for retrieving, as N point one-dimensional DCT data, an input signal of addition/subtraction operation in the addtion/subtraction portion; a transposition portion for transposing a group of one-dimensional DCT data comprised of the N point one-dimensional DCT data at an N point, wherein the N point one-dimensional DCT data is subsequently supplied from the signal output portion; whereby the group of one-dimensional DCT data is supplied from the transposition portion to the signal input portion with respect to each of the N point one-dimensional data to make it possible to retrieve a DCT coefficient data from the signal output portion, which coefficient data is an N point data resulted from both selection in the signal section portion and addition/subtraction in the addition/subtraction portion with respect to each of the N point one-dimensional data.

The DCT device of the present invention capable of determining the DCT coefficients in calculation is based on the DCT matrix decomposing method of the present invention defined in claim 1 and does not employ any multiplier. Due to this, it is possible for the DCT device of the present invention to perform at high speed the DCT operation for converting the input signal into the DCT coefficient. In addition, the DCT device of the present invention is reduced in circuit scale and in power consumption.

### BRIEF DESCRIPTION OF THE DRAWING

FIG. 1 is a schematic block diagram illustrating the DCT device of the present invention.

FIG. 2 is a view illustrating the decomposition of the matrix by using the symmetry of a cosine in the DCT matrix decomposing method of the present invention.

FIG. 3 is a view illustrating the decomposition of the matrix through a factorization operation subsequent to the decomposition of the matrix shown in FIG. 2.

FIG. 4 is a view illustrating the decomposition of the matrix through the factorization operation.

### BEST MODE FOR CARRYING OUT THE INVENTION

With reference to the accompanying drawings, embodiments of the present invention will be described. In a DCT device of the present invention, a two-dimensional DCT operation for converting an image signal into a DCT coefficient, wherein the image signal is split in block unit out of an image of a single frame and each of blocks thus slit out of the frame has a size of 8 pixel×8 pixel, for example.

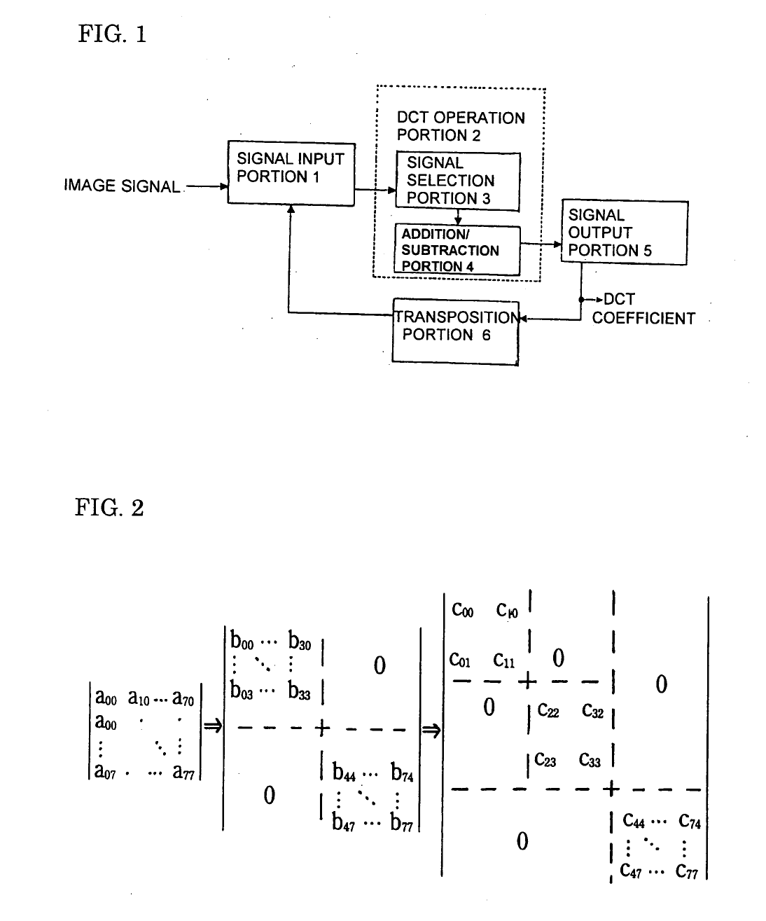

As shown in FIG. 1, the DCT device comprises: an input signal portion 1 in which an 8 point image signal is subsequently inputted in a row direction in each of the blocks; a DCT operation portion 2 in which the 8 point image signal having been inputted through the signal input portion 1 is subjected to a one-dimensional DCT operation; a signal output portion 5 for retrieving a piece of 8 point one-dimensional DCT data having been subjected to the one-dimensional DCT operation; and, a transposition portion 6 for transposing and temporality storing therein a group of one-dimensional DCT data comprised of 8 sets of the 8 point one-dimensional DCT data subsequently supplied from this signal output portion 5. Each of these functional portions is adapted to be controlled in operation by a control portion not shown in the drawings.

When the one-dimensional DCT data with respect to the image signal of each of the blocks has its rows and columns transposed and stored in the transposition portion 6, every row in the group of this DCT data is subsequently supplied from the transposition portion 6 to the DCT operation portion 2 through the signal input portion 1. In the DCT operation portion 2, each of the 8 point one-dimensional data is subjected to the one-dimensional DCT operation, and then retrieved as the DCT coefficient from the signal output portion 5. Incidentally, the DCT coefficient thus retrieved from the signal output portion 5 is further subjected to a quantization process in a quantization portion and to an entropy coding process in an entropy coding portion.

As described above, in the DCT device of the present invention, the one-dimensional DCT operation is repeated to perform the two-dimensional DCT operation.

Here, when the DCT coefficient is represented by F(u,v); the image signal of each block is represented by f(x,y); weight coefficients are represented by Cu, Cv; and, essential components of the transformation function are represented by

Cos[(2x+1)uπ/4]

Cos[(2x+1)vπ/4],

an equation for an N point two-dimensional DCT operation and for an N point one-dimensional DCT operation is represented as follows:

$$\begin{matrix}F ( u , v ) = ( 4 / {N}^{2} ) {C}_{u} {C}_{v} {\sum }_{X = 0}^{N - 1} {\sum }_{Y = 0}^{N - 1} f ( x , y ) cos [ ( 2 x + 1 ) u π / 8 ] cos [ ( 2 x + 1 ) v π / 8 ] \\ F ( u ) = ( 2 / N ) {C}_{u} {\sum }_{X = 0}^{N - 1} f ( x ) cos [ ( 2 x + 1 ) u π / 8 ]\end{matrix}$$

The present invention is characterized by carrying out the one-dimensional DCT operation only through addition and subtraction. In order to realize such DCT operation, the DCT matrix is decomposed into the product of a plurality of matrices by the method inherent in the present invention.

In the present invention, the symmetry of a cosine function is utilized, so that, as shown in FIG. 2, the 8 point one-dimensional DCT matrix is decomposed into: a pair of sub-matrices each having a size of 4 rows×4 columns; and, a pair of zero matrices. Then, one of the sub-matrices having the size of 4 rows×4 columns is further decomposed into: a pair of sub-matrices each having a size of 2 rows×2 columns; and, a pair of zero matrices. Eventually, the 8 point one-dimensional DCT matrix is decomposed into: a pair of the sub-matrices each having the size of 2 rows×2 columns; a single sub-matrix having the size of 4 rows×4 columns; and, four pieces of the zero matrices.

Such decomposition of the 8 point one-dimensional DCT matrix is realized by a high-speed Chen algorithm, for example. In the Chen algorithm, the DCT matrix [AN] for converting the N point input signal [f] into the DCT coefficient [F] performs the decomposition as shown in the following equation, wherein such decomposition is repeatedly performed until the matrix having the size of 2 rows×2 columns appears after the repeated decomposition of the N point one-dimensional DCT matrix:

$$[ AN ] = [ PN ] [ \begin{matrix}{A}_{N / 2} & 0 \\ 0 & {Q}_{N / 2}\end{matrix} ] [ BN ]$$

where: [BN] represents a butterfly matrix. Further,

in a condition in which

$$\{ \begin{matrix}[ PN ] = [ P ( x , y ) ] \\ x , y = 0 , 1 , 2 , … , N - 1 ,\end{matrix} \\ P ( x , y ) takes a value of 1 in a condition in which \\ \{ \begin{matrix}Y = 2 X \\ Y = 2 ( x - N / 1 ) + 1. Otherwise , P ( x , y ) takes a value of zero .\end{matrix} \\ On the other hand , \\ [ QN / 2 ] is represented as follows \text{:} \\ \{ \begin{matrix}[ {Q}_{N / 2} ] = {C}_{2 K + 1} cos \{ ( 2 y + 1 ) ( 2 k + 1 ) π / 2 N \} \\ y , k = 0 , 1 , … , N / 2 - 1\end{matrix}$$

Now, in the present invention, three of the sub-matrices described above are decomposed through factorization so as to be represented by the product of the intermediate matrix and the first matrix the elements of which are 1, −1 or zero in value, wherein the intermediate matrix contains the cosine coefficient values as matrix elements. For example, the sub-matrix having a size of 4 rows×4 columns shown in FIG. 2 is subjected to a factorization operation. As a result, the sub-matrix is converted into the product of a pair of the first matrices and a single intermediate matrix. Among the matrix elements of this intermediate sub-matrix, ones such as doo, d10, d11, d22, d32, d23, d33 are comprised of the cosine coefficient values.

More specifically, when the sub-matrix having the size of 4 rows×4 columns is represented by an expression A4, the sub-matrix A4 is decomposed through a factorization operation as follows, wherein an expression CP/q represents a cos(p/q) π:

$$\begin{matrix}A4 = \vert \begin{matrix}{C}_{1 / 4} & {C}_{1 / 4} & {C}_{1 / 4} & {C}_{1 / 4} \\ {C}_{1 / 8} & {C}_{3 / 8} & {C}_{6 / 8} & {C}_{7 / 8} \\ {C}_{2 / 8} & {C}_{6 / 8} & {C}_{6 / 8} & {C}_{2 / 8} \\ {C}_{3 / 8} & {C}_{7 / 8} & {C}_{1 / 8} & {C}_{5 / 8}\end{matrix} \vert \\ = \vert \begin{matrix}1 & 0 & 0 & 0 \\ 0 & 0 & 0 & 1 \\ 0 & 1 & 0 & 0 \\ 0 & 0 & 1 & 0\end{matrix} \vert \vert \begin{matrix}{C}_{1 / 4} & {C}_{1 / 4} & {C}_{1 / 4} & {C}_{1 / 4} \\ {C}_{1 / 4} & {C}_{3 / 4} & {C}_{3 / 4} & {C}_{1 / 4} \\ {C}_{3 / 8} & - {C}_{1 / 8} & {C}_{1 / 8} & - {C}_{1 / 8} \\ {C}_{1 / 8} & {C}_{3 / 8} & - {C}_{3 / 8} & - {C}_{1 / 8}\end{matrix} \vert \\ = \vert \begin{matrix}1 & 0 & 0 & 0 \\ 0 & 0 & 0 & 1 \\ 0 & 1 & 0 & 0 \\ 0 & 0 & 1 & 0\end{matrix} \vert \vert \begin{matrix}{C}_{1 / 4} & {C}_{1 / 4} & 0 & 0 \\ {C}_{1 / 4} & {C}_{3 / 4} & 0 & 0 \\ 0 & 0 & - {C}_{1 / 8} & {C}_{3 / 8} \\ 0 & 0 & {C}_{3 / 8} & {C}_{1 / 8}\end{matrix} \vert \vert \begin{matrix}1 & 0 & 0 & 1 \\ 0 & 1 & 1 & 0 \\ 0 & 1 & - 1 & 0 \\ 0 & 0 & 0 & - 1\end{matrix} \vert\end{matrix}$$

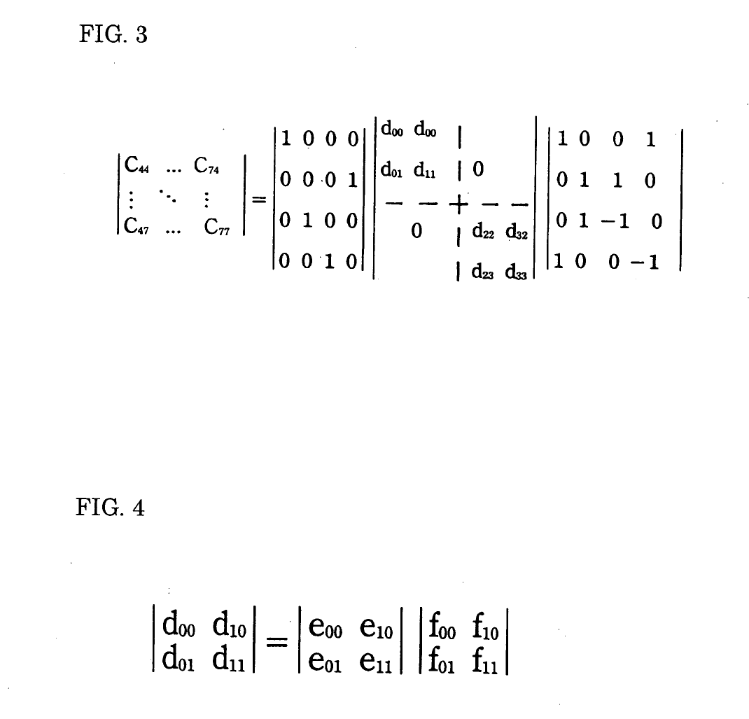

Further, with respect to each of the intermediate matrices, the factorization operation is repeatedly performed a necessary number of times, so that the intermediate is represented by the product of the second sub-matrices the matrix elements of each of which are 1, −1 or zero in value. For example, one of the sub-matrices forming the intermediate matrices shown in FIG. 3 is subjected to the factorization operation so as to be represented by the product of the second matrices, as shown in FIG. 4. The matrix elements e00, e10, e01, e11, f00, f10, f01, f11 of each of the second matrices take values of 1, −1 or zero.

The DCT device of the present invention performs the DCT operation on the basis of the 8 point one-dimensional DCT matrix which is decomposed as described above. In this connection, as shown in FIG. 1, the DCT operation portion 2 is provided with: the signal selection portion 3 for selecting a group of input signals among the 8 point image signals, wherein the group of the input signals corresponds to the plurality of the first matrices or to the first matrix and the plurality of the second matrices; and, the addition/subtraction portion 4 for performing the addition and the subtraction operations for expanding the product of the plurality of the first matrices or the product of the first matrix and the plurality of the second matrices. The addition/subtraction portion 4 is constructed of a predetermined number of adders, subtracters and registers all of which are not shown in the drawings, wherein the registers temporarily store therein the results of the addition operation and the results of the subtraction operation.

Next, the DCT device having the above construction will be described in operation. The image signal is serially transmitted in frame unit to the DCT device. The image signal is split into a plurality of blocks each having a size of 8 pixels×8 pixels. The 8-point image signal in a row direction of each of the blocks is supplied to eight pieces of the signal input terminals of the signal input portion of FIG. 1 through the signal input portion 1 shown in FIG. 1, wherein the eight pieces of the signal input terminals are not shown in the drawings. In the signal selection portion 3, among the 8-point image signals, a group of input signals is selected, provided that the group corresponds to the plurality of the first matrices depending on each of the sub-matrices of the 8 point one-dimensional DCT matrix, or corresponds to the first matrix and the plurality of the second matrices. In such a manner as described above, the group of the input signals, which corresponds to each of the sub-matrices, is selected.

The image signal depending on each of the sub-matrices is supplied to an appropriate one of the adders and the subtracters in a first stage of the addition/subtraction portion 4. The adders and the subtracters of the addition/subtraction portion 4 are connected with each other in a plurality of stages in order to expand: the product of the plurality of the first matrices depending on each of the sub-matrices in the 8 point one-dimensional DCT matrix; or, the product of the first matrix and the plurality of the second matrices. Consequently, the results of operations performed in the adders and the subtracters are supplied to the adders and the subtracters in a stage subsequent to the first stage successively through the registers of the addition/subtraction portion 4.

The result of the addition operations and the results of the subtraction operations performed in the adders and the subtracters, respectively, in a final stage of the addition/subtraction portion 4 represents the result of the one-dimensional DCT operation with respect to the 8 point image signals in the first stage of the block, and is supplied to the transposition portion 6 as a component of the 8 point one-dimensional DCT data having been subjected to the DCT operation. In this transposition portion 6, the DCT data component has its rows and its columns transposed and stored therein temporarily.

Then, with respect to the 8-point image signal in the second stage of the block and a stage subsequent to the second stage, the same DCT operation is subsequently performed so that the 8 point one-dimensional data is stored in the transposition portion 6.

Further, in each of the rows, the 8 point one-dimensional data is supplied from the transposition portion 6 to the DCT operation portion 2 through the signal input portion 1. In the DCT operation portion 2, with respect to the components of the one-dimensional data in each of the rows, as is in the 8-point image signal, the one-dimensional DCT operation is performed. After that, the result of this operation is retrieved from the signal output portion 5 as the DCT coefficient. Such DCT coefficient is then subjected to a quantization process and an entropy coding process, and used as a compressed image signal. The image signal in the remaining blocks is also subjected to the two-dimensional DCT operation as is in the above.

As described above, the DCT device of the present invention is essentially constructed of the adders, the subtracters and the registers, which are connected with each other to form a multi-stage structure. Since the DCT device of the present invention is not provided with any multiplier, it is possible for the DCT device of the present invention to perform the two-dimensional DCT operation at high speed to immediately obtain the DCT coefficient and to remarkably reduce the device in circuit scale and in power consumption.

### INDUSTRIAL APPLICABILITY

The present invention has the construction and the action as described above. Due to this, in the DCT matrix decomposing method of the present invention, it is possible to perform the DCT operation through addition and subtraction operations of the input signal without performing any multiplication operation. Due to this, it is possible for the method of the present invention to improve the DCT operation of the method in operation speed. Further, in the DCT device of the present invention, it is possible to eliminate the multiplier in performing the DCT operation to enhance the operation speed of the DCT operation. It is also possible to remarkably reduce the DCT device of the present invention in circuit scale and in power consumption thereof.

1. A DCT matrix decomposing method characterized by comprising: a first step of decomposing an N×N one-dimensional DCT matrix into a plurality of sub-matrices and a zero matrix by using the symmetry of a cosine function; a second step of factorizing each of the sub-matrices to make it possible to express each of the sub-matrices by the product of an intermediate matrix and one or more first matrices the elements of which are 1, −1 or 0 in value, wherein the intermediate matrix contains a cosine coefficient as a matrix element; and, a third step of repeating a factorization process of each of the intermediate matrices a necessary number of times to make it possible to express each of the intermediate matrices by the product of second matrices the elements of which are 1, −1 or 0 in value.

2. A DCT device characterized by comprising: a signal input portion for inputting an N point input signal; a signal selection portion for selecting a group of input signal among the N point signals, which group corresponds to one or more of a plurality of first matrices, or to the first matrix and a plurality of second matrices, wherein the first and the second matrices are obtained with respect of each of the sub-matrices defined in claim 1 by performing the first to the third steps defined in claim 1; an addition/subtraction portion for performing addition and subtraction operations for expanding the product of the first matrix and the plurality of the second matrices, or the product of the plurality of the first matrices with respect to the group of the input signals, which group depends on each of the sub-matrices and is selected in the signal section portion; a signal output portion for retrieving, as N point one-dimensional DCT data, an input signal of addition/subtraction operation in the addtion/subtraction portion; a transposition portion for transposing a group of one-dimensional DCT data comprised of the N point one-dimensional DCT data at an N point, wherein the N point one-dimensional DCT data is subsequently supplied from the signal output portion; whereby the group of one-dimensional DCT data is supplied from the transposition portion to the signal input portion with respect to each of the N point one-dimensional data to make it possible to retrieve a DCT coefficient data from the signal output portion, which coefficient data is an N point data resulted from both selection in the signal section portion and addition/subtraction in the addition/subtraction portion with respect to each of the N point one-dimensional data.
